(19) United States
(12) Patent Application Publication
(10) Pub. No.: US 2006/0283371 A1
(43) Pub. Date: Dec. 21, 2006

(54) Non-slip device which is used to mark determined points on thin layers

(75) Inventor: Ariel Faskowicz, Barcelona (ES)

Correspondence Address: OSTROLENK FABER GERB & SOFFEN, 1180 AVENUE OF THE AMERICAS, NEW YORK, NY, 100368403, US

(73) Assignee: TUK PLUS CREACIONS, S.L., Barcelona (ES)

(21) Appl. No.: 10/554,650

(22) PCT Filed: Mar. 3, 2004
(86) PCT No.: PCT/ES04/00099

§ 371 Date: Oct. 26, 2005

(30) Foreign Application Priority Data
Mar. 6, 2003 (ES) U200300643

(51) Int. Cl. B42D 9/00

(52) U.S. Cl. 116/234

(57) ABSTRACT

Slip-proof device for marking specific spots in thin films, whether these are of paper, cloth or other materials, such as pages of books or magazines. It is formed by a plate of a thin material, rigid, semi-rigid or flexible, divided into two bodies joined by a blank such that each one can be folded on the other. Said blank incorporates a flap that simplifies handling the device. The rear face of each body has a magnet, so that when the device is folded the magnets will attract each other and create a magnetic field that can cross the film, so that the two bodies will be attached to one another requiring to exert a force in the opposite direction to separate them. After the device is set in place it will remain there, hindering any accidental displacement but allowing such a displacement when desired.

### FIELD OF THE INVENTION

As described in the title of this descriptive memory, the present invention relates to a device for marking specific spots in thin films, made of paper, cloth or other materials, such as pages of books or magazines. The device is designed so that after it is placed in a specific place it will remain there, hindering involuntary displacements, yet allowing to displace it if desired. This characteristic makes it ideal, for example, for use as a page marker in a book, as it fulfils the following characteristics: it is easy to place, it will not move accidentally after it is placed, it will not fall out if the book is opened at the marked page, it can mark a specific page and line, it can be easily removed from its position and it can be used to identify the thin film to which it is adhered.

### PRIOR ART

Currently, the problem of marking a specific spot in thin films is generally solved by mechanical devices which, by an elastic deformation, are placed at the desired spot and released, so that they tend to recover their original form, pressing and deforming the film, or if it is rigid maintaining a certain elastic deformation. One example of these devices is the well-known clip, which is also normally used to hold two films against each other. The drawback of this system is that it affects the film in a mechanical sense, deforming it, and it makes it difficult to slide the marker on the film so that in order to change its position it is generally necessary to remove it and then place it at the new position.

When the aim is to mark a specific film in a multiple-film element, such as appointment books, notebooks, magazines or books, other solutions are available: (a) simple strips of cardboard or any other rigid or semi-rigid material; (b) flexible cords or ropes attached to the spine of the multiple-page element; (c) small self-adhesive pieces of paper, used as markers. Solutions (a) and (b) allow marking a page but not a spot within the page, while solution (c) allows marking a specific spot but the adhesive wears out with use, so that after a time they cease to work.

### DESCRIPTION OF THE INVENTION

The device of the invention consists of a thin plate of a rigid, semi-rigid or flexible material divided into two bodies which are joined to each other such that one can fold over the other, thereby allowing the two rear faces to touch. Two magnets placed on the rear face of each body will keep the two rear faces attached to each other due to their magnetic attraction, such that a force must be exerted in the opposite sense to separate them.

The magnets are such that the magnetic field formed between them can pass through thin films (such as sheets of paper) allowing to fold the two bodies with the aforementioned film between them and maintain the above-described attractive force between the two bodies.

The two bodies can have different lengths so that the main body can be identified easily, thereby allowing to indicate in the film the position and the face to be marked.

The blank between the bodies can be made in a non-linear shape, so that when it is folded a flap is defined that allows handling the device when placing or removing it.

The entire rear face of the device (in both bodies) may be coated with a thin film so that, in addition to providing a finish that improves the appearance and safety of the device, the device can be placed on the film directly with the second body folded on the first body, simply sliding it through the film without the edges of the magnets colliding with the edge of the film.

Either of the two bodies can be provided with an identification device, whether optical, mechanical, electronic, acoustic or of any other form. This device allows to identify the invention or the film to which it is attached.

### BRIEF DSCRIPTION OF THE DRAWINGS

FIG. 1. Shows the anterior face of the device. The upper body 1, lower body 2 and blank 5 can be recognized.

FIG. 2. Shows the rear face of the device. The upper body 1, lower body 2, upper body magnet 3, lower body magnet 4 and blank 5 can be recognized.

FIG. 3. Shows the device with the upper body folded on the lower body, so that the two rear faces tend to touch each other, although in the position shown in the figure the upper body must travel somewhat more for this to take place. The folded upper body 1, the lower body 2, the upper body magnet 3 and the flap 6 formed when folding due to the blank can all be recognized.

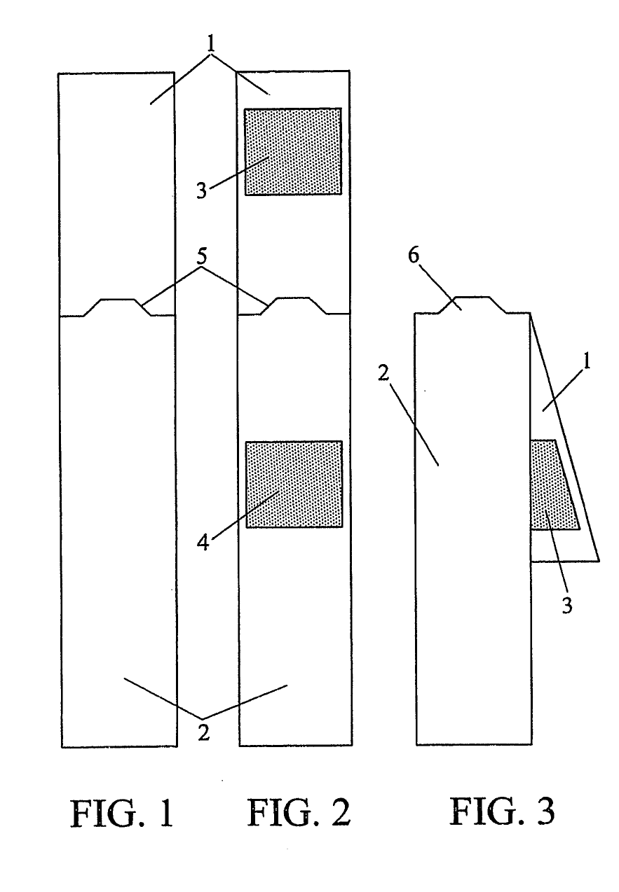

### DETAILED DESCRIPTION OF AN EMBODIMENT OF THE INVENTION

In view of the aforementioned figures it can be seen that the device comprises the two bodies 1 and 2, respectively upper and lower. The rear face of each body bears corresponding magnets 3 and 4 at identical distances measured from the blank 5. The blank in turn has a central non-linear part that is fully cut and two lateral linear parts that are marked to facilitate folding. In this way when it is folded the flap 6 is obtained, which simplifies placing and removing the device.

The material of both bodies can be rigid, semi-rigid or flexible (such as cardboard, etc.). The magnets are glued to the corresponding body.

The following sequence must be carried out to place the device in the tin film to be marked: (a) fold the body 2 on the body 1, so that the two magnets touch each other and the attractive force is exerted; (b) slide the device from the edge of the film inwards, so that the film is between the two bodies; (c) move the device to the spot to be marked.

To remove the device from the film simply grip it by the flap 6 and pull away from the film gently until the two magnets touch each other.

1. Slip-proof device to mark spots in thin films, characterized in that it is formed by a plate of a rigid, semi-rigid or flexible material, it comprises two bodies not necessarily identical in length joined to each other by a blank, and it has two magnets, one on the rear face of each body, said magnets placed such that when one body is folded on the other their surfaces meet and an attraction is exerted that prevents the two bodies from being separated unless a mechanical force is applied on them.

2. Slip-proof device to mark spots in thin films, according to claim 1, with a blank that is non-linear, one part of it being fully cut so that when one body is folded on the other one or more flaps are defined that facilitate handling the device, and another uncut part so that the two bodies are kept together while allowing to fold one body on the other.

3. Slip-proof device to mark spots in thin films, according to claim 1, having its rear face coated with a protective film which, in addition to improving the finish of the device and protecting the magnets, allows a simple positioning preventing the edges of the magnets from colliding with the edge of the thin film to be marked.

4. Slip-proof device to mark spots in thin films, according to claim 1, having on any of its bodies one or more identification devices of an optical, mechanical, electrical, acoustic type or of any other technical nature.

5. Slip-proof device to mark spots in thin films, according to claim 1, whose bodies, magnets and flap have non-straight shapes: curved, rounded, oblique or with fanciful shapes.
